(19) United States
(12) Patent Application Publication
(10) Pub. No.: US 2023/0151279 A1
(43) Pub. Date: May 18, 2023

(54) PROCESS AND SYSTEM FOR PRODUCING A HYDROCARBON-CONTAINING AND HYDROGEN-CONTAINING GAS MIXTURE FROM PLASTIC

(71) Applicants: Markus Reissner, Klipphausen (DE); Andreas Reissner, Dresden (DE); Patrick Reissner, Dresden (DE)

(72) Inventors: Markus Reissner, Klipphausen (DE); Andreas Reissner, Dresden (DE); Patrick Reissner, Dresden (DE)

(21) Appl. No.: 17/767,567

(22) PCT Filed: Oct. 6, 2020
(86) PCT No.: PCT/EP2020/077901

§ 371 Date: Apr. 8, 2022

(30) Foreign Application Priority Data
Oct. 9, 2019 (WO) 19202155.8

(51) Int. Cl. C10B 53/07; C01B 3/32; C10B 47/30; C10K 1/02; C10K 1/10; C10K 1/12; C10K 1/32; C10K 3/02; B01D 46/42; B01D 39/06

(52) U.S. Cl. CPC C10B 53/07; C01B 3/326; C10B 47/30; C10K 1/024; C10K 1/101; C10K 1/122; C10K 1/32; C10K 3/023; B01D 46/4263; B01D 39/06; C01B 2203/0233; C01B 2203/0415; C01B 2203/042; C01B 2203/1041; C01B 2203/1058; C01B 2203/1211; C01B 2203/0465; B01D 2273/20

(57) ABSTRACT

The invention relates to a method and a system for producing a hydrocarbon- and hydrogen-containing gas mixture from plastics, and the use of the system for producing this gas mixture and the use of this gas mixture as a starting material in chemical syntheses or for gas supply.

The invention relates to a method and an installation for producing a hydrocarbon- and hydrogen-containing gas mixture from plastics and the use of a hydrocarbon- and hydrogen-containing gas mixture produced by means of the method and/or produced by means of the system as a starting material in chemical syntheses or for gas supply.

The production of plastics is increasing every year due to the advantageous properties, such as low weight, inexpensive manufacture and functional properties, in particular stability and durability, which also increases the amount of plastics waste.

Most plastics are not biodegradable. Degradation is therefore only possible by means of thermal conversion, in particular combustion or pyrolysis.

In addition to energy recovery, raw material recovery is also possible. Raw material recovery is understood to mean thermal treatment of the plastics to crack the polymer chains into petrochemical basic materials.

DE 3030593 A1 describes a method and a device for the economical and environmentally friendly use of biomass and organic waste, in particular plastics, by means of pyrolysis. DE 3030593 A1 discloses the production of coal, oils and gases by thermal decomposition at a temperature in the range of 1,000° C. to 1,300° C., oxidation and fractionation.

US 2014/020286 A1 discloses a catalyst for a method and system for microwave pyrolysis. The pyrolysis system comprises a reactor having a waste inlet, a liquid inlet, and an interior coating for preventing the deposition of microwave-reactive residues in the reactor, and a microwave source which emits microwaves inside the reactor. US 2014/020286 A1 further describes a catalysis unit in the pyrolysis unit for increasing the stability of the gas.

US 2007/179326 A1 discloses a method and a system for the thermodynamic conversion of waste materials into reusable fuels, comprising pyrolysis, wherein the waste materials are converted into the gas phase with a supply of oxygen and pressure control. This is followed by the transfer into a catalysis unit, preferably comprising a metal catalyst and at least one condenser.

US 2012/308441 A1 discloses a method and an system for producing “clean” electrical energy and liquid hydrocarbons from biomass, waste products and oil sand, comprising a plurality of pyrolysis units which are heated by an infrared system and the heat of the pyrolysis units. Furthermore, US 2012/308441 A1 discloses a high-temperature filter made of ceramics, which is located between the membrane oxygen extraction subsystem and the end of the last converter of the pyrolysis subsystem, filtration of the gas after the pyrolysis and before the operation of a turbine generator with the gas, a filter for separating sulphur, and a filter for separating carbon and residual sulphur. Furthermore, US 2012/308441 A1 describes the combination of pyrolysis with an electrolysis and/or a catalysis unit and/or a closed fractionating column for the production of hydrogen.

EP 0 567 449 A1 discloses a multi-stage method for the thermal conversion of organic substances into gases comprising carbon monoxide and hydrogen (synthesis gas) under the action of oxygen and steam in a fixed bed reactor at temperatures of over 900° C. and at least 5 bar pressure in the reactor, the fixed bed being a consuming bed made of carbon and/or highly condensed hydrocarbons, in particular coke. Cooling is then preferably carried out by means of a water bath and/or washing in water. The disadvantage is that the reactor has to have a pressure of at least 5 bar. Another disadvantage is that the organic substances require additional heating, in particular due to the petroleum residues.

EP 0 563 777 B1 discloses a method for the production of synthesis gas by thermal treatment of residues containing metal and organic components, in particular for the treatment of packaging materials made of aluminium and plastics material, the residues being broken down in a pyrolysis reaction at 300 to 500° C. and separated into a gas phase and a solid phase, the separated solid phase being introduced into a gasification stage and gasified with oxygen at a very high temperature in the range of 1,450 to 1,850° C. The two gas fractions are then converted into synthesis gas with the addition of steam in a decomposition stage under reducing conditions and under increased pressure at temperatures between 800 and 1,250° C.

U.S. Pat. No. 9,200,207 B2 discloses the production of liquid, high-quality hydrocarbon fuels from plastics waste with the addition of a metal hydride, preferably MgH₂, CaH₂, palladium hydride, BeH₂, AlH₃, InH₃, LiAlH₄, NaAlH₄, NaBH₄; and a metal catalyst, the metal catalyst being selected from Pt, Pd, Ir, Ru, Rh, Ni, Co, Fe, Mn, Mg, Ca, Mo, Ti, Zn, Al, metal alloys of Pt—Pd, Pt—Ru, Pt—Pd—Ru, Pt—Co, Co—Ni, Co—Fe, Ni—Fe, Co—Ni—Fe and combinations thereof, and the catalyst support material preferably being selected from Al₂O₃, SiO₂, zeolites, zirconia (ZrO₂), MgO, TiO₂, activated carbon, clays and combinations thereof. Gasification takes place at a temperature of 300° C. to 800° C. and at a pressure of 1 atm to 20 atm.

US 2019/0119191 A1 describes a method for converting plastics materials into waxes (>C₂₀) by pyrolysis and catalytic cracking within a reactor, the pyrolysis gas having a short residence time of at most 60 s at a temperature above 370° C. Short-chain hydrocarbons which have lengths <C₄ are preferably separated by means of pre-treatment.

CN 108456328 A describes a method for processing plastics waste by means of a modified catalyst and a solvent, in particular a mixture of tetrahydronaphthalene and n-hexadecane, in a catalytic pyrolysis reactor, the catalyst being an oxide-modified HZSM-5 (Zeolite Socony Mobil-5) and HY (acid form zeolite Y) composite molecular sieve catalyst having a Sn, Fe, Ti or Zn modification, and with the supply of hydrogen. The reaction is carried out at a temperature of 150 to 300° C. and a pressure of 4 to 7 MPa. A disadvantage is that organic solvents and hydrogen are required for the method for processing plastics.

The disadvantage of known methods is the low purity of the obtained gases, in particular the obtained synthesis gas (carbon monoxide and hydrogen), and the high energy requirement for carrying out the processes. In many cases, large amounts of filter dusts, sludges and liquids are produced, which are toxic and have to be disposed of in a costly manner.

A further disadvantage of known methods is that they function at very high temperatures and high pressures. This is accompanied by technological requirements, higher energy requirements and greater material stress. In spite of all this, there has hitherto been no method which produces a homogeneous gas from unsorted mixed plastics that hardly contains any long-chain hydrocarbons (>C₄).

The problem addressed by the invention is that of providing a method and a device for gasifying plastics, in particular waste containing plastics, such as composite materials or plastics-coated metal materials. Gasification, i.e. the conversion of the plastic components into a usable hydrocarbon- and hydrogen-containing gas mixture, should be simple and efficient, and in particular cost-effective and energy-saving. The obtained gas mixture should be as pure and as high-quality as possible.

The problem is solved by a method for producing a hydrocarbon- and hydrogen-containing gas mixture from plastics, comprising the following steps:
A) pyrolysis of plastics to form a pyrolysis gas mixture,
B) hot gas filtration to separate solid particles,
C) catalytic cracking to produce the hydrocarbon- and hydrogen-containing gas mixture, and
D) cleaning the hydrocarbon- and hydrogen-containing gas mixture.

The pyrolysis in step A) converts the solid plastics into gases, oils and tars containing numerous long-chain hydrocarbons (>C₄). The catalytic cracking in step C) cracks these hydrocarbons into short-chain, more usable hydrocarbons (C₁-C₄). Solids are separated in the hot gas filtration in step B), the oil fraction and tar fraction advantageously still being allowed to pass through.

The hydrocarbon- and hydrogen-containing gas mixture according to the invention, which is obtained by the method according to the invention and the device according to the invention, also encompasses a gas mixture, which contains further components, in particular synthesis gas components, i.e. CO and H₂.

Within the meaning of the invention, the term “plastics” includes plastic mixtures and plastics, which is contained in plastics-containing materials, such as metal-plastic mixtures or composite materials. Residues or waste materials containing plastics, which originate from packaging materials, inter alia, are preferably used as the plastics. Advantageously, the invention can be applied to uncleaned and mixed plastics (i.e. plastics which are not homogenous or contain foreign substances).

The subject matter of the invention is also an system for producing a hydrocarbon- and hydrogen-containing gas mixture, in particular the above-mentioned gas mixture, from plastics, comprising
a) a pyrolysis unit,
b) a hot gas filter,
c) a unit for catalytic cracking,
d) a gas scrubbing unit.

In step A) of the method according to the invention, the plastics or the plastic mixture is thermally treated. In the obtained pyrolysis gas mixture, large portions of the oil fraction and the tar fraction are often still dispersed in the gas phase, and smaller solid particles are also present. In step B), the hot pyrolysis gas mixture is filtered to deposit solid particles. The filtered gas mixture is catalytically cracked in step C), such that the hydrocarbon- and hydrogen-containing gas mixture is formed. In this case, various components are reduced and long-chain hydrocarbons (also tars and oils) are cracked into shorter-chain hydrocarbons. In step D), the gas mixture is cleaned.

The advantage of the invention is that the method according to the invention can also be used for composite materials, which contain plastics. Furthermore, no pre-treatment of the plastics is necessary using the method according to the invention.

It is also advantageous that no solvents or additives such as metal hydrides are required, and the method is therefore simple.

A further advantage is that the temperatures and pressures can be kept low (below 900° C.) in the method according to the invention or in the system according to the invention; in particular, no overpressure is necessary, as is the case with gasification methods in the prior art. The invention thus allows the hydrocarbon- and hydrogen-containing gas mixture according to the invention to be produced in a cost-effective and energy-saving manner.

Another important advantage is that the gas mixture obtained is very pure and high-quality. Such a gas is high-quality or pure if it no longer contains any or only very few long-chain hydrocarbons (>C₄). A high hydrogen content also contributes to the high quality of the gas for other uses. The gas mixture is advantageously high-quality, since it contains a lot of hydrogen (>20%, in particular >30%) and no long-chain hydrocarbons (>C₄), but only short-chain hydrocarbons (C₁-C₄).

In this context, it is advantageous for the liquids produced during the drying of the gas product to only contain so few toxic ingredients such as oils, tars and phenols that the liquids no longer have to be incinerated as hazardous waste. The majority of these toxic ingredients are broken down into short-chain hydrocarbons, inter alia, before the gas is dried.

By means of the invention, a high conversion is achieved (i.e. the mass of the hydrocarbon and hydrogen in the obtained gas mixture in relation to the mass of the plastics used), advantageously more than 95% conversion.

It is also advantageous that, due to the arrangement of the steps in the method and the design of the system, the O₂ content (oxygen content) can be controlled during the method, in particular can be kept very low during the pyrolysis in step A). Therefore, during the pyrolysis of the plastics, there is no unwanted combustion of hydrogen or other combustible components, which would be necessary for subsequent industrial usability of the gas.

The method preferably takes place in the order of the method steps mentioned at the outset. In this embodiment, the system parts of the system according to the invention are also arranged in the corresponding order.

In preferred embodiments, the method according to the invention is carried out continuously.

In embodiments, a separation of non-pyrolysable solids, in particular metals, takes place in step A) of the method or in the pyrolysis unit a) of the system.

The pyrolysis in step A) is preferably carried out continuously, i.e. the material input and/or output takes place automatically, in particular the input and/or output of the solids.

In further embodiments, the plastic is input into the pyrolysis unit a) of the system or for the pyrolysis A) in the method by means of a stuffing screw, the screw flight stopping before the end, in particular 0.5 m before, and the end being equipped with a weighted flap. The advantage is that, as a result, the input plastic is compacted and the oxygen input is thus reduced. The non-pyrolysable solid is preferably output by means of a double pendulum flap, which prevents oxygen from entering the interior during the output.

In embodiments, the pyrolysis in step A) takes place with a temperature gradient. The pyrolysis preferably takes place in step A) in at least three, preferably four, zones with an increasing temperature.

In the method according to the invention, in particular in step A), or in the system according to the invention, plastics selected from plastic-metal composites (such as lightweight aluminium packaging) and mixed plastics and mixtures thereof is preferably used.

In a preferred embodiment of the method, the pyrolysis in step A) is carried out at a low oxygen content in the range of 0% (v/v) to 2% (v/v), particularly preferably at an oxygen content of at most 1.5% (v/v), in particular at an oxygen content of at most 1.1%. This almost inert atmosphere in the interior during the pyrolysis is advantageous in that there is no unwanted combustion of hydrogen or other combustible components, which are necessary for subsequent industrial usability of the gas. The gas would lose valence at an excessively high oxygen content.

It is also preferable for the pyrolysis in step A) to be carried out at a temperature in the range of 300° C. to 600° C., particularly preferably from 350° C. to 550° C., in particular from 380° C. to 540° C.

In embodiments, the pyrolysis in step A) takes place at a negative pressure in the range of 0 mbar to 1 mbar relative to the external pressure, particularly preferably in the range of 0.1 mbar to 0.5 mbar, in particular 0.2 mbar. The term “external pressure” is understood to mean the pressure, which prevails outside the system.

In embodiments of the method, the hot gas filtration in step B) is carried out at a temperature in the range of 500° C. to 600° C., in particular at 550° C. In this case, the pipes which lead from the pyrolysis unit to the hot gas filter and the inner wall of the hot gas filter are also heated to this temperature in order to prevent solid and liquid dispersed components, such as oils and tar, from settling on the pipe walls. Inorganic substances such as metals or other dusts, in particular heavy metals, are also advantageously separated in the gaseous form by the hot gas filtration.

In the catalytic cracking in step C), the temperature is preferably in the range of 800° C. to 950° C., in particular 850° C. to 900° C. The oxygen content in this step is preferably in the range of 12% (v/v) to 15% (v/v), which advantageously results in the formation of coke/carbon being prevented.

In embodiments, air and steam are supplied in this method step. The advantage of steam is that it prevents the formation of solid carbon during the catalytic cracking. The advantage of the air supply is that it corrects the temperature.

In a preferred embodiment of the method according to the invention, a further step A2) is carried out between steps A) and B) or between steps B) and C):
A2) catalytic cracking of the pyrolysis gas mixture, the obtained gas mixture then being used in step B) or in step C).

Likewise, in one embodiment of the system according to the invention, said system additionally comprises a
a2) pre-reformer which is used for this catalytic cracking of the gas mixture which previously exits the pyrolysis unit or the hot gas filter. In this embodiment, the system thus allows catalytic cracking in at least two stages or components of the system.

The term “pre-reformer” is understood to mean a unit for catalytic cracking which is upstream of the unit for catalytic cracking (c).

In these embodiments of the method or the system, the oils and tars (sometimes also solid components) contained in the pyrolysis gas mixture from step A) or step B) are catalytically pre-cracked into short-chain or shorter-chain hydrocarbons, such that they can also be converted to the hydrocarbon- and hydrogen-containing gas mixture in the further process. This conversion is thus further increased.

The pre-reformer (a2) is preferably a fluidised-bed reformer.

In a preferred variant of these embodiments, the pyrolysis gas mixture from step A) or step B) is catalytically cracked, i.e. method step A2), at the same temperatures and pressure conditions as the catalytic cracking in step C), such that in this case the subsequent step B), hot gas filtration, or step C), catalytic cracking, also takes place at this temperature. In this method step, a negative pressure in the range of 0 mbar to 1 mbar relative to the external pressure, particularly preferably in the range of 0.1 mbar to 0.5 mbar, in particular 0.2 mbar, preferably prevails in the pre-reformer in which this step takes place.

In embodiments of the method according to the invention, steam and/or an oxygen-containing gas mixture is supplied in step C) and/or in step A2).

In a preferred embodiment of the system according to the invention, the unit for catalytic cracking c) and/or the pre-reformer for catalytic cracking a2) has a steam inlet and an inlet for air or oxygen or just one inlet for both. As a result, steam and air or oxygen are also preferably supplied in steps C) and/or A2) in the method according to the invention.

In embodiments of the system according to the invention, the unit for catalytic cracking c) has a steam inlet and/or an inlet for an oxygen-containing gas mixture or an inlet for steam and an oxygen-containing gas mixture.

In further embodiments of the system according to the invention, the pre-reformer a2) has a steam inlet and/or an inlet for an oxygen-containing gas mixture or an inlet for steam and an oxygen-containing gas mixture.

In preferred embodiments of the system according to the invention, the unit for catalytic cracking c) and the pre-reformer a2) each have a steam inlet and/or an inlet for an oxygen-containing gas mixture or an inlet for steam and an oxygen-containing gas mixture.

In embodiments of the method according to the invention, steam is supplied in step C) and an oxygen-containing gas mixture is supplied in step A2).

In further embodiments of the method according to the invention, steam is supplied in step A2) and an oxygen-containing gas mixture is supplied in step C).

In further preferred embodiments of the method according to the invention, steam and an oxygen-containing gas mixture are supplied in step C) and in step A2).

In a preferred embodiment of the method according to the invention, the catalytic cracking in step C) and, if carried out, also the catalytic cracking in step A2) take place by means of a catalyst selected from limestone, zirconium dioxide (ZrO₂), noble metal and nickel catalysts, in particular from a nickel catalyst and a limestone catalyst such as fluidised limestone (dolomite). The advantage of a limestone catalyst is that it also reduces chlorine and sulphur.

In embodiments, the catalytic cracking in step C) and the catalytic cracking in step A2) take place using the same catalyst or different catalysts. The catalytic cracking in step C) and the catalytic cracking in step A2) preferably take place using different catalysts.

In preferred embodiments, the catalytic cracking in step A2) takes place by means of a limestone catalyst, in particular fluidised limestone (dolomite), or a ZrO₂ catalyst, and/or the catalytic cracking in step C) takes place by means of a nickel catalyst.

In embodiments, after the catalytic cracking in step C), water is separated from the hydrocarbon- and hydrogen-containing gas mixture by condensation. The separation of water from the hydrocarbon- and hydrogen-containing gas mixture by condensation in step D) preferably takes place by cooling the gas to 0° C.

In further embodiments, the system according to the invention comprises a condenser, it being possible for the condenser to be arranged upstream and/or downstream of the gas scrubbing unit d).

In one embodiment of the method, the gas scrubbing in step D) takes place in an alkaline solution and in another, in particular acidic or neutral, solution, in particular first in the alkaline solution. The neutral solution is particularly preferably pure water. In a preferred embodiment, the cleaning additionally takes place by means of adsorption on activated charcoal.

The term “solution” is understood to mean a liquid or a fluid.

Foreign substances such as sulphur, hydrogen sulphide, ammonia, fluorine, chlorine, bromine or heavy metals are advantageously reduced to a concentration of <1 ppm during the gas scrubbing in water.

The adsorption on activated charcoal particularly preferably takes place last, with the gas being heated beforehand, passed through a condensation stage for drying, and then passed through activated charcoal beds. The concentration of impurities such as sulphur, hydrogen sulphide, ammonia, halogen or heavy metals is advantageously reduced to below 1 ppb.

In a preferred embodiment of the system, the system is also designed in such a way that it allows these individual steps, i.e. it has devices for passing a gas through a liquid and particularly preferably additionally has activated carbon beds through which a gas can be passed.

In a preferred embodiment of the method, the gas scrubbing in step D) takes place at a temperature in the range of 0° C. to 10° C.

In a preferred embodiment, the pyrolysis unit comprises a pyrolysis drum.

Preferably, a) the pyrolysis unit is a rotary kiln pyrolysis unit or a fluidised bed pyrolysis unit, particularly preferably a rotary kiln pyrolysis unit. The advantage of the rotary kiln pyrolysis unit is that, due to the typical design and the sealing, it is particularly easily possible to provide an oxygen-poor atmosphere in the interior. In this embodiment, in order to reduce unnecessary oxygen input, it is particularly preferred to continuously flush the input and output with nitrogen (the input is the opening of the pyrolysis unit where the plastic is supplied and the output is the opening where the solids, such as metals, that remain after the pyrolysis are discharged).

In a preferred embodiment of the system according to the invention, b) the hot gas filter has filter candles made of aluminium silicate wool. The container of the hot gas filter is preferably made of stainless steel, at least on the inside, and can also be heated such that, advantageously, no oils or tars are deposited.

It is also preferred that one or more of the connections between the system parts a) to c) can be heated. In particular, system parts a) to c), i.e. also a2), can also themselves be heated, advantageously to the temperatures provided for the associated step of the method according to the invention. Each component can expediently be heated separately.

It is also preferred that the system has at least one device for pressure reduction, in particular at the end of the system which is designed to be gas-tight.

A further aspect of the invention relates to the use of a hot gas filter having filter candles made of aluminium silicate wool in a method or a system for producing a hydrocarbon- and hydrogen-containing gas mixture from plastics, preferably in a method and/or an system according to the invention.

In embodiments, a hot gas filter comprising a container is used, the container being made of stainless steel at least on the inside.

In further embodiments, a heatable hot gas filter is used. Advantageously, no oils or tars are deposited in the hot gas filter due to the heating.

The subject matter of the invention is also the use of the system according to the invention for producing a hydrocarbon- and hydrogen-containing gas mixture from plastics, in particular the use in the method according to the invention.

Finally, the invention also relates to the use of a hydrocarbon- and hydrogen-containing gas mixture, produced by means of the method according to the invention and/or produced by means of the system according to the invention, as a starting material in chemical syntheses, such as Fischer-Tropsch synthesis, or for gas supply, such as gas supply for heating purposes, power generation or as fuel.

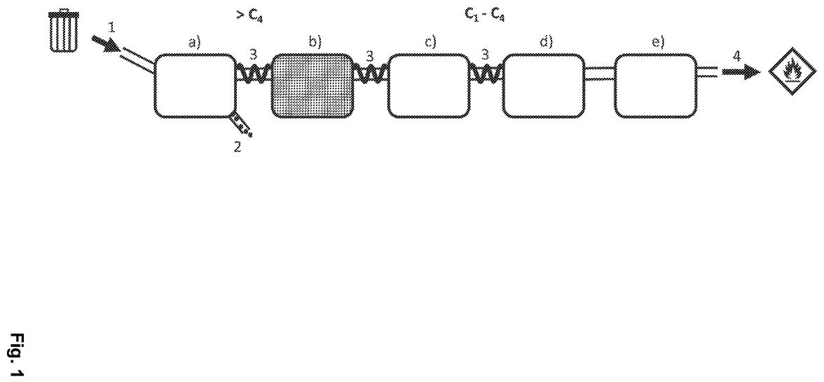

FIG. 1 shows the schematic structure of the system according to the invention in an exemplary embodiment.

In order to implement the invention, it is also expedient to combine the above-described embodiments and features of the claims.

### EMBODIMENTS

The invention will be explained in greater detail below with reference to some embodiments and accompanying drawings. The embodiments are intended to describe the invention without limiting it.

Method when Using Aluminium Packaging Waste Containing Plastics:

Aluminium packaging waste with plastics (so-called composite material) was used as the plastics.

A) The material is input into the pyrolysis unit via a stuffing screw. The stuffing screw flight stops approximately 0.5 m before the end and the end is fitted with a weighted flap. The pyrolysis drum is an indirectly heated drum having four heating zones which can be controlled independently. The input and output of the pyrolysis unit are continuously flushed with nitrogen. A measurement of the oxygen content in the pyrolysis drum gives approximately 1%. The four heating zones cover a range of 380-520° C. The temperature measurement of the gas in the pyrolysis drum gives 480-540° C.

The pyrolysis drum has a bypass flap by means of which excess heat can be dissipated without heating the drum. The pressure in the pyrolysis unit is 0.2 mbar below the external pressure. The solid waste is output via a double pendulum flap which is designed as a sluice in order to prevent oxygen from entering the housing during the output. The waste (mainly metal) is cooled and mechanically processed. The obtained gas is conducted to the hot gas filter via heated pipes.

B) The gas is fed into the hot gas filter from below and passed through filter candles made of aluminium silicate wool. The dust becomes caught on the candles and the cleaned gas rises to the top. The container of the hot gas filter consists of stainless steel and is heated to 550° C. The dust is automatically removed via differential pressure-controlled cleaning with nitrogen. The filtered gas is in turn passed through a heated pipe for catalytic cracking.
C) The reformer used, i.e. the unit for catalytic cracking, is in two-stages. The inflowing gas mixture is enriched with air and conducted past a ZrO₂ catalyst. The temperature of the gas in this case is between 850-900° C. After this first stage, steam is added to the gas and the gas is then conducted past a nickel-based fixed bed catalyst.

For the first time, the gas is then conducted via non-heated pipelines, specifically to the condenser, where it is cooled to 0° C. and a liquid phase condenses. This liquid phase no longer contains any oils, tars or phenols, and it therefore does not have to be incinerated as hazardous waste.

D) The gas is then conducted to the gas scrubbing unit. At approx. 0-10° C., the gas is first passed through a NaOH solution and next passed over pure water, in order to then be conducted for gas ultra-purification. There the gas is reheated and then condensed again in order to dry it again and to then pass it through an activated carbon bed.

Method with Additional Catalytic Cracking a2) Between the Pyrolysis and the Hot Gas Filtration:

The method is carried out as described above. Only the two-stage catalytic cracking in step C) is one-stage cracking, since catalytic cracking is now also carried out in step A2). The temperature of the gas in step A2) is 850-900° C. A fluidised bed reformer is used with a dolomite (fluidised limestone) catalyst. In addition, air and steam are added. In this case, the hot gas filtration is also carried out at 850-900° C., such that nothing condenses in the subsequent hot gas filtration. The remaining steps take place analogously.

The compositions of various gases listed below were determined using gas chromatography-MS.

Composition of the Pyrolysis Gas after Step A):

1.3% H₂, 7.8% CO₂, 4.1% CO, 2.2% CH₄, 1.3% O₂, 72.4% N₂, 7.5% hydrocarbons >C₄, 3.4% hydrocarbons C₂-C₄.

Composition of the Hydrocarbon- and Hydrogen-Containing Gas Mixture from Step C):

40% H₂, 17% CO₂, 5% CO, 7% CH₄, 0.5% O₂, 28% N₂.

Method when Using Mixed Plastics Waste:

The method is carried out in the two variants, as mentioned above. The obtained gases have the following compositions:

Composition of the Pyrolysis Gas after Step A):

| | Sample numbering | | | | | | |
|---|---|---|---|---|---|---|---|
| | 1 | 2 | 3 | 4 | 5 | 6 | 7 |
| | vol. | vol. | vol. | vol. | vol. | vol. | vol. |
| | % | % | % | % | % | % | % |
| CH₄ | 2.9 | 2.7 | 2.4 | 2.9 | 2.6 | 2.7 | 3.0 |
| H₂ | 1.9 | 3.1 | 2.6 | 2.0 | 1.9 | 1.4 | 1.6 |
| N₂ | 71.8 | 68.6 | 70.0 | 70.5 | 72.4 | 72.7 | 70.5 |
| O₂ | 0.5 | 0.2 | 0.3 | 0.4 | 0.5 | 0.4 | 1.2 |
| CO₂ | 8.5 | 13.5 | 12.4 | 9.4 | 9.0 | 8.5 | 8.1 |
| CO | 7.1 | 3.8 | 4.0 | 6.2 | 6.5 | 6.8 | 6.7 |
| C₂H₆ (ethane) | 1.09 | 1.25 | 1.29 | 1.47 | 1.00 | 1.12 | 1.37 |
| C₂H₄ (ethylene) | 1.84 | 1.96 | 2.01 | 2.08 | 1.50 | 1.70 | 1.80 |
| C₃H₈ (propane) | 0.25 | 0.39 | 0.46 | 0.41 | 0.24 | 0.30 | 0.41 |
| C₃H₆ (propylene) | 1.51 | 1.71 | 1.88 | 2.01 | 1.29 | 1.47 | 1.82 |
| iso-C₄H₁₀ (iso-butane) | 0.00 | 0.00 | 0.00 | 0.00 | 0.00 | 0.00 | 0.00 |
| n-C₄H₁₀ (n-butane) | 0.04 | 0.07 | 0.09 | 0.07 | 0.04 | 0.05 | 0.08 |
| C₃H₄ (propadiene) | 0.00 | 0.01 | 0.01 | 0.00 | 0.00 | 0.00 | 0.00 |
| C₂H₂ (acetylene) | 0.01 | 0.09 | 0.08 | 0.00 | 0.00 | 0.00 | 0.00 |
| C₄H₈ (trans-2-butene) | 0.06 | 0.08 | 0.09 | 0.08 | 0.05 | 0.06 | 0.07 |
| C₄H₈ (iso-butene) | 0.00 | 0.50 | 0.51 | 0.40 | 0.25 | 0.26 | 0.38 |
| C₄H₆ (1,3-butadiene) | 0.08 | 0.13 | 0.12 | 0.10 | 0.07 | 0.07 | 0.08 |
| C₅H₁₂ (iso-pentane) | 0.00 | 0.00 | 0.00 | 0.00 | 0.00 | 0.00 | 0.00 |
| C₅H₁₂ (pentane) | 0.09 | 0.20 | 0.26 | 0.15 | 0.07 | 0.10 | 0.16 |
| C₅H₁₀ (1-pentene) | 0.10 | 0.05 | 0.05 | 0.04 | 0.09 | 0.11 | 0.15 |
| C₆H₆ (benzene) | 0.02 | 0.49 | 0.54 | 0.53 | 0.40 | 0.33 | 0.37 |
| C₇H₈ (toluene) | 0.02 | 0.02 | 0.03 | 0.04 | 0.03 | 0.03 | 0.03 |
| Unidentifiable | | | | | | | |
| hydrocarbons: | | | | | | | |
| C4 hydrocarbons | 0.00 | 0.00 | 0.00 | 0.00 | 0.00 | 0.00 | 0.00 |
| C5 hydrocarbons | 0.60 | 0.65 | 0.68 | 0.68 | 0.35 | 0.42 | 0.54 |
| C6 hydrocarbons | 0.82 | 0.75 | 0.94 | 0.80 | 0.50 | 0.55 | 0.73 |
| C7 hydrocarbons | 0.04 | 0.06 | 0.10 | 0.09 | 0.06 | 0.07 | 0.08 |

Various samples were also analysed for H₂S, polyaromatic hydrocarbons, chlorine and ammonia:

| | Sample | | | | |
|---|---|---|---|---|---|
| | i | ii | iii | iv | v |
| | vol. ppm | vol. ppm | vol. ppm | vol. ppm | vol. ppm |
| H₂S | 5 | 6 | 12 | 5 | 8 |

The samples contained, inter alia, the following amounts of polyaromatic hydrocarbons (PAH). These values were determined by means of gas chromatography-MS (g/man=grams per m³ standard condition—0° C. and 101.325 kPa).

| | Sample | | | | | |
|---|---|---|---|---|---|---|
| | I | II | III | IV | V | VI |
| | g/m³n | g/m³n | g/m³n | g/m³n | g/m³n | g/m³n |
| Benzene | 16 | 9 | 10 | 15 | 12 | 11 |
| Light tars | 99 | 82 | 123 | 140 | 153 | 132 |
| (<naphthalene) | | | | | | |
| Naphthalene | 1 | 1 | 2 | 2 | 2 | 2 |
| Heavy tars | 21 | 49 | 85 | 99 | 87 | 66 |
| (>naphthalene) | | | | | | |
| Carbon black | 6 | 44 | 21 | 10 | 1 | 2 |
| Water | 208 | 136 | 181 | 190 | 755 | 230 |

Sample

| | x | Reference/zero sample |
|---|---|---|
| | mg/l | mg/l |
| Chlorine (HCl) | 278 | 0.22 |

Sample

| | y | z |
|---|---|---|
| | mg/l | mg/l |
| NH₃ | 64 | 109 |

Composition of the Hydrocarbon- and Hydrogen-Containing Gas Mixture from Step C) and Step D):

In addition to nitrogen, hydrogen, oxygen, carbon dioxide and carbon monoxide, the samples contained the following hydrocarbons, inter alia:

| | Sample | | | |
|---|---|---|---|---|
| | m | n | o | p |
| | ppm | ppm | ppm | ppm |
| CH₄ | 40,196 | 43,334 | 73,747 | 70,944 |
| C₂H₆ (ethane) | 2,234 | 683 | 2,012 | 2,169 |
| C₂H₄ (ethylene) | 40,700 | 18,329 | 83,247 | 50,523 |
| C₃H₈ (propane) | 226 | 2 | 97 | 49 |
| C₃H₆ (propylene) | 7,568 | 418 | 3,948 | 5,265 |
| iso-C₄H₁₀ (iso-butane) | 7 | 0 | 1 | 0 |
| n-C₄H₁₀ (n-butane) | 37 | 0 | 0 | 1 |
| C₃H₄ (propadiene) | 36 | 48 | 3,931 | 1,973 |
| C₂H₂ (acetylene) | 82 | 857 | 0 | 0 |
| C₄H₈ (trans-2-butene) | 176 | 1 | 16 | 21 |
| C₄H₈ (iso-butene) | 2,141 | 15 | 15 | 399 |
| C₄H₆ (1,3-butadiene) | 1,689 | 108 | 1,416 | 1,706 |
| C₅H₁₂ (iso-pentane) | 2 | 0 | 0 | 0 |
| C₅H₁₂ (pentane) | 111 | 1 | 8 | 0 |
| C₅H₁₀ (1-pentene) | 883 | 0 | 1 | 1 |
| C₆H₆ (benzene) | 949 | 4,016 | 9,535 | 6,737 |
| C₇H₈ (toluene) | 430 | 301 | 1,054 | 1,248 |
| C₆H₁₂ (cyclohexane) | 3 | 18 | 167 | 112 |
| C₇H₁₄ (methylcyclohexane) | 5 | 0 | 1 | 2 |
| Unidentifiable | | | | |
| hydrocarbons: | | | | |
| C4 hydrocarbons | 1,741 | 2 | 562 | 339 |
| C5 hydrocarbons | 968 | 64 | 513 | 552 |
| C6 hydrocarbons | 4,662 | 34 | 421 | 388 |
| C7 hydrocarbons | 914 | 8 | 902 | 102 |

Obtained Conversions:

The conversion is calculated on the basis of the molar volume for ideal gases of 22.4 l/mol. This means that, from the volume of the relevant gas in the hydrocarbon- and hydrogen-containing gas mixture obtained in the method, the substance amount is calculated in mol by means of this molar volume of 22.4 l/mol, which substance amount can in turn be converted into the mass of the gas by means of the molar mass of the gas. The sum of the masses of the individual contained gases is set in relation to the mass of the plastics used, and the conversion is thus obtained.

The conversion was 95%, 92.5% and 98% in the individual experiments.

### LIST OF REFERENCE SIGNS

a) pyrolysis unit
b) hot gas filter
c) unit for catalytic cracking
d) condenser
e) gas scrubbing unit
1 plastics input
2 output of non-pyrolysable solids (metal)
3 heated pipes
4 output of the hydrocarbon- and hydrogen-containing gas mixture

1. A method for producing a hydrocarbon and hydrogen-containing gas mixture from plastics, comprising the following steps:
A) pyrolysis of plastics to form a pyrolysis gas mixture;
B) hot gas filtration for removal of solid particles;
C) catalytic cracking to produce the hydrocarbon-containing and hydrogen-containing gas mixture; and
D) gas wash of the hydrocarbon-containing and hydrogen-containing gas mixture, wherein between step A) and B) or between step B) and C) a further step A2) is carried out:
A2) catalytic cracking of the pyrolysis gas mixture, wherein water vapor and air or oxygen are added during the catalytic cracking comprising steps C) and A2).

2. (canceled)

3. The method according to claim 1, wherein the plastics in step A) is selected from lightweight aluminium packaging and mixed plastics.

4. The method according to claim 1, wherein a separation of solids takes place in step A).

5. The method according to claim 1 wherein the pyrolysis in step A) is carried out at an oxygen content in the range of 0% (v/v) to 2% (v/v).

6. The method according to claim 1 wherein the pyrolysis in step A) is carried out at a temperature in the range of 300° C. to 600° C.

7. The method according to claim 1, wherein the pyrolysis in step A) is carried out at a negative pressure in the range of 0 mbar to 1 mbar relative to the external pressure.

8. The method according to claim 1 wherein the hot gas filtration in step B) is carried out at a temperature in the range of 500° C. to 600° C.

9. The method according to claim 1 wherein the catalytic cracking is carried out by means of a catalyst selected from limestone, zirconium dioxide (ZrO2), noble metal and nickel catalysts.

10. A system for producing a hydrocarbon-containing and hydrogen-containing gas mixture from plastics, comprising:
a) a pyrolysis unit;
b) a hot gas filter;
c) a unit for catalytic cracking; and
d) a gas scrubbing unit comprising:
a2) a pre-reformer for catalytic cracking of the pyrolysis gas mixture, wherein the pre-reformer is arranged downstream of the a) pyrolysis unit or the b) hot gas filter, wherein the catalytic cracking unit c) and the catalytic cracking reformer a2) together have at least one inlet for water vapor and air or oxygen,
for the production of a hydrocarbon and hydrogen-containing gas mixture from plastic wherein the at least one inlet at the unit for catalytic cracking c) and the pre-reformer for catalytic cracking a2) is used for the inlet of water vapor and air or oxygen.

11. (canceled)

12. The system according to claim 10 wherein the pyrolysis unit is a rotary kiln pyrolysis unit or a fluidised bed pyrolysis unit.

13. The system according to claim 10, wherein one or more of the connections between the system parts a) to c) can be heated.

14. The system according to claim 10, wherein the hot gas filter has filter cartridges made of aluminum silicate wool.

15. (canceled)

16. The method according to claim 1, wherein step B) is carried out using a hot gas filter wherein the hot gas filter has filter cartridges made of aluminum silicate wool.

17. (canceled)

18. (canceled)

19. (canceled)

20. (canceled)
